(19) United States
(12) Patent Application Publication
(10) Pub. No.: US 2004/0119742 A1
(43) Pub. Date: Jun. 24, 2004

(54) System and method for manipulating objects in graphical user interface

(75) Inventors: Marc A. Silbey, Seattle, WA (US); Sandra B. Barnat, Seattle, WA (US); Gail Borod Giacobbe, Seattle, WA (US); Alan B. Auerbach, Sammamish, WA (US); Michelle D. McKelvey, Seattle, WA (US); Cornelis K. van Dok, Bellevue, WA (US); Jordan L.K. Schwartz, Seattle, WA (US); Kelly L. Ford, Redmond, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Microsoft Corporation

(21) Appl. No.: 10/325,629

(22) Filed: Dec. 18, 2002

(51) Int. Cl. G09G 5/00

(52) U.S. Cl. 345/760; 345/821

(57) ABSTRACT

A system and method for providing a hybrid list view of display objects are provided. A screen display includes a number of display objects that can be selected for manipulation and selected to initiate an action. Each display object can include a graphical selection control to toggle a selection status, a foreground portion to an action and a background portion to toggle a selection status and initiate an action. Software applications generate list view screen displays incorporating display objects and can process an additional variety of user inputs.

### FIELD OF THE INVENTION

In general, the present invention relates to computer software, and in particular, to a system and method for manipulating display objects in a graphical user interface.

### BACKGROUND OF THE INVENTION

Generally described, individuals can interact with software applications residing on computing devices, such as personal computers, hand-held computers, mobile computing devices, and the like for a variety of purposes. In one particular embodiment, the development of graphical user interfaces facilitate user interaction with these various software applications resident on the computing device. For example, a user may manipulate a graphical user interface to interact with a data processing application or to communicate with other computing devices and/or users via a communication network.

In a typical embodiment, a graphical user interface can display a number of display objects that are individually manipulable by a user utilizing a user interface device. For example, the user can utilize a computer mouse, touch screen, touch pad, roller ball or voice commands and the like to select a particular display object and to further initiate an action corresponding to the selected display object. In one particular embodiment, software applications may utilize a display template for displaying a number of display objects within a graphical view window corresponding to a particular software application to utilize functionality provided by the software application. For example, many software applications utilize an ordered display template, generally referred to as a list view, that corresponds to a table format in which individual display objects are represented as rows of the table and defined by the columns in the table.

There are two typical approaches as to how a user interacts with display objects formatted in list view display template: a single input selection, double input activation model and a single input selection, single input activation model. In both approaches, the typical user selection device is either a computer mouse, touch pad, touch screen, other touch sensitive devices, keyboard, or other input devices that registers a user movement of a display cursor, and some form of control selection. In this regard, a single input refers to the selection of a control, such as pressing of a mouse control button, touch pad control button, or the tapping of a touch sensitive screen interface a single time within a short period of time or the pressing of a key on a keyboard assigned to register a single input (e.g., space bar). Similarly, a double input refers to the selection of a control two successive times within the same short period of time or the pressing of a key on a keyboard assigned to register a double input (e.g., enter). The action of generating single inputs and doubt inputs are well known in the art, and will not be described in any further detail. Depending on how a particular list view is configured, the generation of a single input and/or double input on a display object results in a modification of an attribute of the display object and/or the initiation of one or more actions by the software application.

FIG. 1 is a block diagram illustrative of a screen display 100 corresponding to a list view utilizing a single input selection, double input activation model. In accordance with this embodiment, the screen display 100 is organized in table format that includes a number of display objects that can be selected for manipulation and/or used to initiate an action. As illustrated in FIG. 1, each manipulable data object is represented as a row in the table. The list view can also include a number of columns 102 that correspond to various information associated with each display object. For example, the screen display may correspond to an electronic mail program in which each display object corresponds to an electronic mail message represented as a row and each column corresponds to various attributes of each electronic mail message, such as a such as a subject column, a date column, and the like.

In accordance with the single input selection, double input action model, each display object is selectable by a single input from the user interface device. Typically, a selection of an object is accompanied by highlighting the selected display object. A subsequent single input to the selected display object toggles the selection status to “unselected.” To activate the object, the user must either activate a separate control, such as a control button, indicating a desire to activate the selected display object or provide a double input on an actionable portion of the display object. In one embodiment, the actionable portion 104 may be limited to a specific icon, such as icon portion on the display object. In an alternative embodiment, the entire display object, including all foreground text and graphics and any background portions may correspond to the actionable portion such as a double input anywhere within that row will activate the display object. With reference to an electronic mail program example, selection of a display object may allow a user to manipulate individual messages, such as deleting the message. Likewise, activation may result as the generation of a new display window containing the entire text of the mail message.

In addition to the manipulation of single display objects within a list view, the single input selection, double input activation allows users to manipulate multiple display objects with additional selection controls. FIG. 2 is a block diagram of the screen interface 100 of FIG. 1 illustrating the selection of multiple objects within a list view implementing a single input selection, double input activation model. As described above, a single input corresponds to the selection of a particular display object. If an additional selection control is selected, such as pressing a particular key on the keyboard or multiple selection graphic control, a selection of a second object by a single input results in the selection of at least both display objects and possibly additional display objects within the list view. In one embodiment, a particular multiple selection control allows for the selection of only the display objects that have been selected by a single input. For example, as illustrated in FIG. 2, a single input on display objects 104 and 106 would result in the selection of only those two display objects. In another embodiment, a particular multiple selection control allows for the inclusive selection of all display objects located between the two display objects selected by a single input. As illustrated in FIG. 2, a single input on display object 104 and display object 106 would result in the selection of all display objects between the two selected objects.

FIG. 3 is a block diagram of a screen display 300 corresponding to a list view utilizing a single input selection, single input activation model. Examples of such user interfaces are commonly found in screen displays corresponding to network connectors, such as World Wide Web display pages and/or software applications including navigable display objects. As illustrated in FIG. 3, the screen display 300 is organized in a table format that presents a number of display objects as rows in the table and that provides information about each display object within the columns of the table.

In accordance with the single input selector, single input activation mode, each display object may be selected by the generation of a single input from a user interface device. However, the single input must correspond to a particular graphical selection control. For example, a common graphical control is a check box 304 that is toggled by single inputs from a user selection device. A single input on any other portion of the display object will not toggle the selection status to the display object. To activate a selected display object, the user provides a single input on an actionable portion of the display object, such as portion 306, or activate a separate control, such as a control button, indicating a desire to activate the selected display object. In a typical embodiment, the actionable portion corresponds to a hyperlink that causes the software application to proceed to another screen display. A single input on a non-actionable portion will not result in an activation. Additionally, a double input in the model provides no further functions.

The single input selection, single input activation model also allows for multiple selection, but in a more limited manner. With reference now to FIG. 4, in a single input selection, single input activate model, a user cannot typically use additional multiple selection controls to select objects. Instead, the user is limited to individually selecting the desired display objects by toggling the graphic selection control portion, check box 304, of each display object. Further, inclusive multiple selection controls are generally not provided.

Generally described, software applications utilize either a single input selection, double input activation model, or a single input activation, single input activation model for generating a list view user interface. Accordingly, the typical user must be knowledgeable in manipulating display objects both user interface models. If a user prefers a single input selection, single input activation model while the software designer utilizes a single input selection, double input activation model, the user must generally conform to the software designer's specification. Accordingly, software designers must conduct feasibility studies or marketing studies to determine the most beneficial list view display model. Alternatively, the software designer can maintain multiple versions of the same software application to accommodate user preferences.

Therefore, there is a need for a system and method for manipulating display objects in a graphical user interface that facilitates a combination of multiple list view manipulation model such that a user is provided a number of selection and activation controls.

### SUMMARY OF THE INVENTION

A system and method for providing a hybrid list view of display objects are provided. A screen display includes a number of display objects that can be selected for manipulation and selected to initiate an action. Each display object can include a graphical selection control to toggle a selection status, a foreground portion to an action and a background portion to toggle a selection status and initiate an action. Software applications generate list view screen displays incorporating display objects and can process an additional variety of user inputs.

In accordance with an aspect of the present invention, a method for managing display objects in a screen display presented on the computer system display is provided. The method may be implemented in a computer system having a display and a user selection device for registering single and double inputs. Each display object can be selected for manipulation and activated to cause performance of some action within the computer system.

In accordance with the method, a computing device obtains a set of display objects corresponding to a screen display. Each display object includes a graphical control for selecting the display object with a single input, at least one foreground portion for activating the display object with a single input, and a background portion for selecting the display object with a single input and activating the display object with a double input. The computing device generates a screen display including the set of display objects and obtains a user input generated by the user selection device. The user input corresponds to a display object in the screen display. The computing device then processes the user input corresponding to a display object in the screen display.

In accordance with another aspect of the present invention, a method for managing display objects in a screen display presented on the computer system display is provided. The method may be implemented in a computer system having a display and a user selection device for registering single and double inputs. Each display object can be selected for manipulation and activated to cause performance of some action within the computer system.

In accordance with the method, a computing device obtains a set of display objects corresponding to a screen display. Each display object includes a graphical control for selecting the object with a single input and a background portion for selecting an object with a single input. The computing device generates a screen display including the set of display objects and obtains a user input generated by the user selection device. The user input corresponds to a display object in the screen display and is selected from a group comprising a single input on the graphical control of the display object and a single input on the background portion of the display object. The computing device then toggles a selection status of the display object in the screen display.

In accordance with a further aspect of the present invention, a computer-readable medium having computer-executable components corresponding display objects in a computer display is provided. The computer-executable components are implemented in a computer system having a display for displaying display objects that can be selected for manipulation and activated to cause the performance of an action within the computer system and a user interface device for generating single and double inputs. The computer-executable components include a graphical control component for toggling a selection status of the display object with a single input. The computer-executable components also include a foreground component for activating the display object with a single input. Additionally, the computer-executable components include a background component for toggling the selection status of the display with a single input and for activating the display object with a double input.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram of a screen display illustrating a single input selection double input activation list view;

FIG. 2 is a block diagram of the screen display of FIG. 1 illustrating multiple selection control of display objects in a single input selection, double input activation list view;

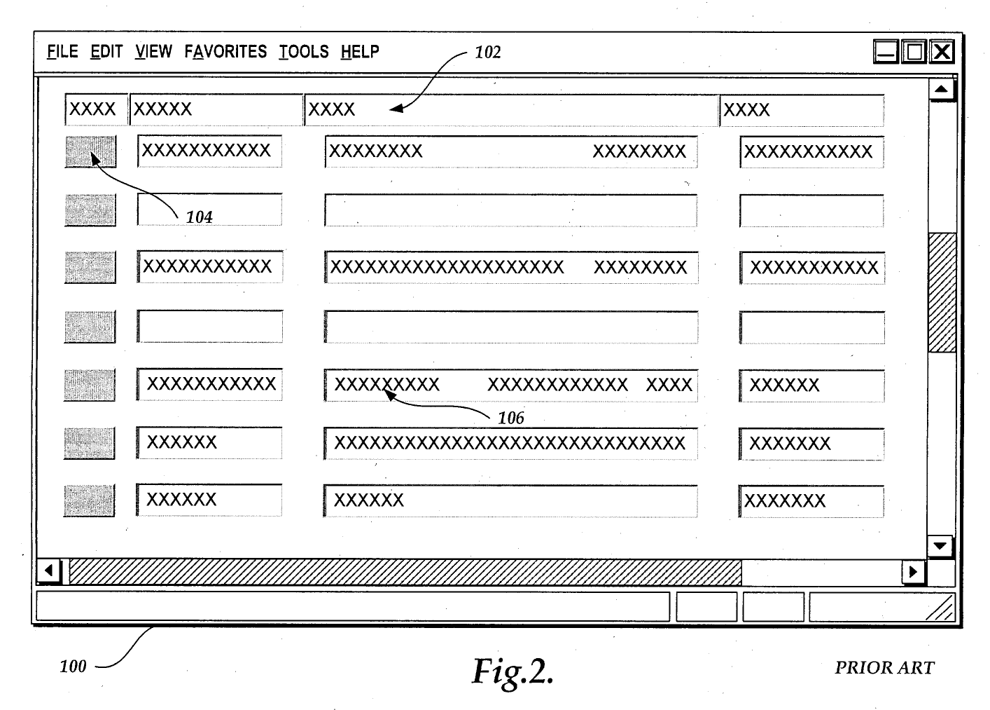

FIG. 3 is a block diagram illustrative of a screen display presenting a single input selection, single input activation list view;

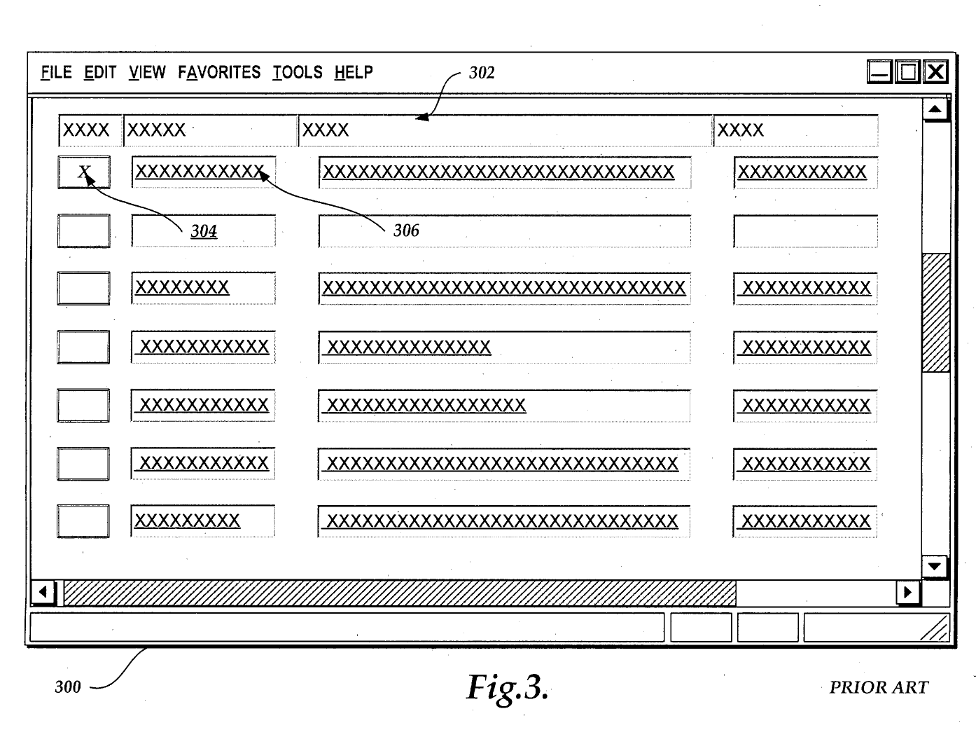

FIG. 4 is a block diagram with a screen display of FIG. 3 illustrating the multiple selection control of display objects in a single input selection, single input activation list view;

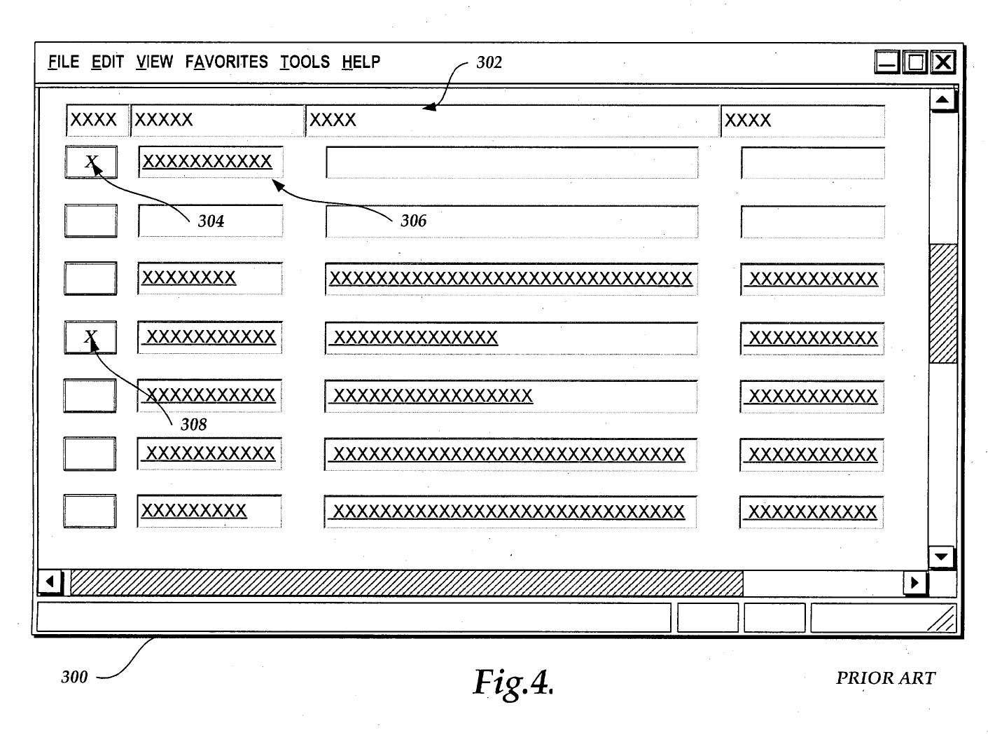

FIG. 5 is a block diagram of a screen display illustrating a hybrid display object selection and activation list view formed in accordance with the present invention;

FIG. 6 is a block diagram of the screen display of FIG. 5 illustrating the multiple selection of display objects in a hybrid selection and activation list view in accordance with the present invention;

FIG. 7 is a flow diagram illustrative of a list view display object manipulation routine implemented in accordance with the present invention;

FIG. 8A is a flow diagram illustration of a single input processing sub-routine implemented in accordance with the present invention;

FIG. 8B is a flow diagram illustrative of a double input processing subroutine implemented in accordance with the present invention;

FIG. 9 is a flow diagram illustrative of a multiple selection control processing sub-routine implemented in accordance with the present invention;

FIG. 10 is a flow diagram illustrative of a process hover input sub-routine in accordance with the present invention; and

FIG. 11 is a block diagram of a computing system suitable for implementing aspects of the present invention.

### DETAILED DESCRIPTION OF THE PREFERRED EMBODIMENT

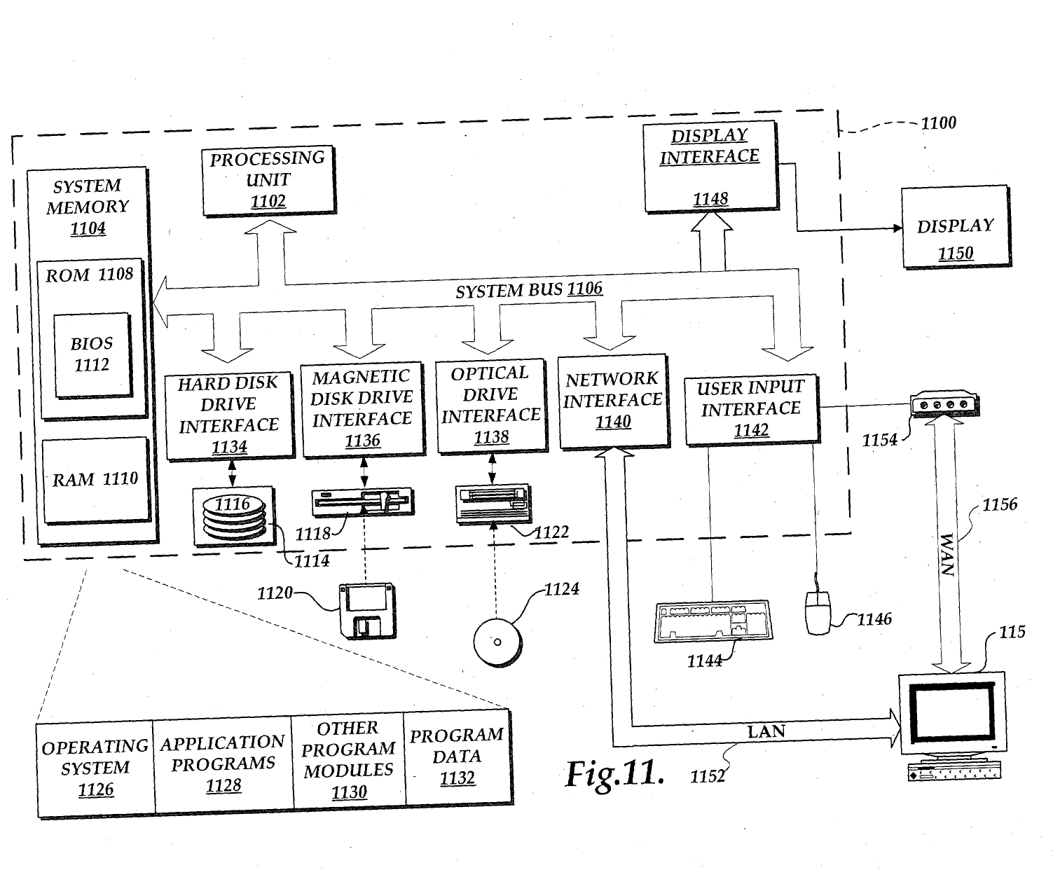

FIG. 11 illustrates an example of a suitable computing system environment in which the invention may be implemented. The computing system environment is only one example of a suitable computing environment and is not intended to suggest any limitation as to the scope of use or functionality of the invention. Neither should the computing environment be interpreted as having any dependent requirement relating to any one or combination of components illustrated in the exemplary operating environment.

The invention is operational in numerous other general purpose or special computing system environments or configurations. Examples of well known computing systems, environments, and/or configurations that may be suitable for implementing the invention include, but are not limited to, personal computers, server computers, laptop devices, multiprocessor systems, microprocessor-based systems, network PCs, minicomputers, mainframe computers, or distributed computing environments that include any of the above systems or the like.

The invention may be described in the general context of computer-executable instructions, such as program modules, being executed by a computer. Generally, program modules include routines, programs, objects, components, data structures, etc., that perform a particular task or implement particular abstract data types. The invention may be also practiced in distributed computing environments where tasks are performed by remote processing devices that are linked through a communications network. In a distributed computing environment, program modules may be located in both local and remote computer storage media including memory storage devices.

With reference to FIG. 11, an exemplary system for implementing the invention includes a general purpose computing device in the form of a computer 1100. Components of a computer 1100 include, but are not limited to, a processing unit 1102, a system memory 1104, and a system bus 1106 that couples various system components including the system memory to the processor. The system bus may be any of several types of bus structures including a memory bus or memory controller, peripheral bus, and a local bus using any of a variety of bus architectures. By way of example, not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as a Mezzanine bus.

The computer 1100 typically includes a variety of computer-readable media. Computer-readable media can be any available media that can be accessed by the computer 1100 and includes both volatile and non-volatile media, removable and non-removable media. By way of example, and not limitation, computer-readable media may comprise computer storage media and communication media. Computer storage media includes, but is not limited to, RAM, ROM, EEPROM, flash memory or other memory technology, CD-ROM, Digital Versatile Disk (DVD) or other optical disk storage, magnetic cassettes, magnetic tape, magnetic disk storage or other magnetic storage devices, or any other medium which can be used to store the desired information and which can be accessed by the computer 1100.

The communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner to encode information in the signal. By way of example, and not limitation, communication media includes wired media such as a wired network or direct wired connection, and wireless media such as acoustic, RF, infrared and other wireless media. Combinations of any of the above should also be included within the scope of computer-readable media.

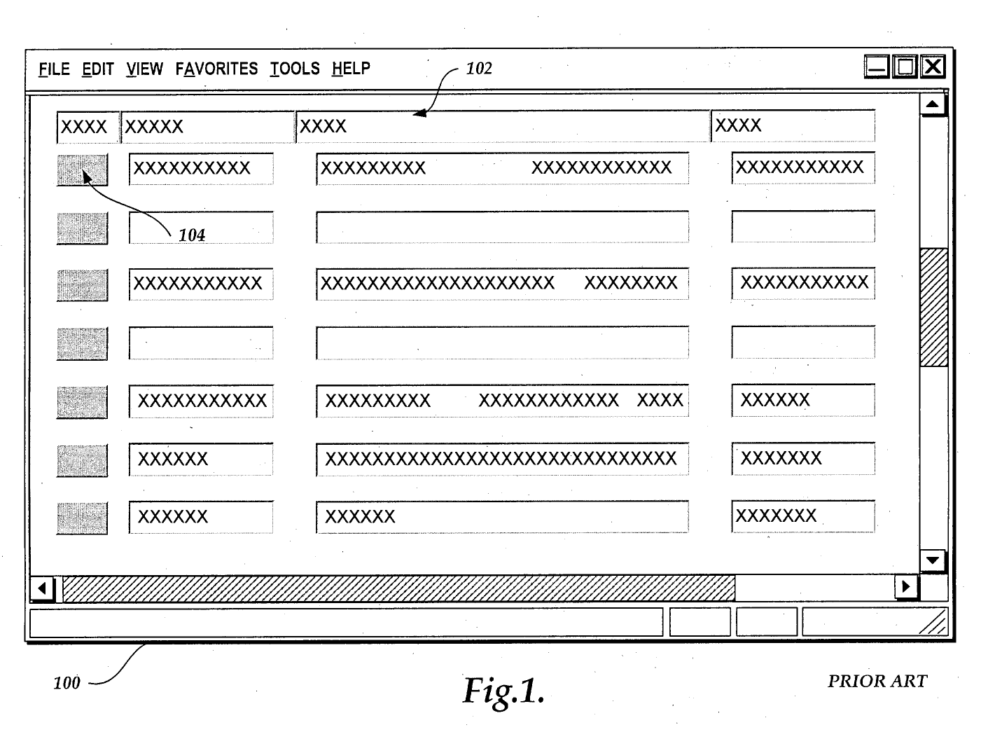

The system memory 1104 includes computer storage media in the form of volatile and/or non-volatile memory such as read only memory (ROM) 1108 and random access memory (RAM) 1110. A basic input/output system 1112 (BIOS), containing the basic routines that help to transfer information between elements within the computer 1100, such as during start-up, is typically stored in ROM 1108. RAM 1110 typically contains data and/or program modules that are immediately accessible to and/or presently being operated on by the processing unit 1102. By way of example, and not limitation, FIG. 1I illustrates an operating system 1126, application programs 1128, other program modules 1130, and program data 1132.

The computer 1100 may also include removable/non-removable, volatile/non-volatile computer storage media. By way of example only, FIG. 11 illustrates a hard disk drive 1114 that reads from or writes to non-removable, non-volatile magnetic media 1116, a magnetic drive 1118 that reads from or writes to a removable, non-volatile magnetic disk 1120, and an optical disk drive 1122 that reads from or writes to a removable, non-volatile optical disk 1124, such as CD-ROM, or other optical media. Other removable/non-removable, volatile/non-volatile computer storage media that can be used in the exemplary operating environment include, but are not limited to, magnetic tape cassettes, flash memory cards, DVD, digital video tape, Bernoulli cap cartridges, solid state RAM, solid state ROM, and the like. The hard disk drive 1114, magnetic disk drive 1118, and optical disk drive 1122 may be connected to the system bus 1106 by a hard disk drive interface 1134, a magnetic disk drive interface 1136, and an optical drive interface 1138, respectively. Alternatively, the hard disk drive 1114, magnetic disk drive 1118, and optical disk drive 1122 are typically connected to the system bus 1106 by a Small Computer System Interface (SCSI).

The drives and their associated computer storage media discussed above and illustrated in FIG. 11, provide storage of computer-readable instructions, data structures, program modules and other data for the computer 1100. In FIG. 11, for example, the hard disk drive 1134 is illustrated as storing the operating system 1126, application programs 1128, other programs 1130, and program data 1132. Note that these components can either be the same as or different from the operating system 1126, the other program modules 1130, and the program data 1132. A user may enter commands and information into the computer 1100 through an input device such as a keyboard 1144 and/or a pointing device 1146, commonly referred to as a mouse, track ball or touch pad. Other input devices (not shown) may include a microphone, a joystick, a game pad, a satellite dish, a scanner, or the like. These and other input devices are often connected to the processing unit 1102 through user input interface 1142 and may be connected by other interface and bus structures, such as a parallel port, game port or other universal serial bus (USB).

The computer 1100 may operate in a network environment using logical connections to one or more remote computers 1154. The remote computer 1154 may be a personal computer, a server, a router, a network PC, a peer device or other common network node, and typically includes many or all of the elements described above relative to the computer 1100, although only a memory storage device has been illustrated in FIG. 11. The logical connections depicted in FIG. 11 include a local area network (LAN) 1148 and a wide area network (WAN) 1152, but also include other networks. Such network environments are commonplace in office, enterprise-wide computer networks, Intranets, and the Internet.

When used in a LAN network environment, the computer 1100 is connected to the LAN 1148 through a network interface adapter 1140. When used in a WAN network environment, the computer typically includes a modem 1150 or other means for establishing communications over the WAN 1152, such as the Internet. The modem, which may be internal or external, may be connected to the system bus 1106 via the serial port interface or other appropriate mechanism. In a networked environment, program modules depicted relative to the computer 1100, or portions thereof, may be stored in the remote memory storage device. By way of example, and not limitation, FIG. 11 illustrates remote application programs 1128 as residing on memory device 1104. It will be appreciated that the network connections shown are exemplary and other means of establishing communication between the computers may be used. Although many other internal components of the computer 1100 are not shown, those of ordinary skill will appreciate that such components and their interconnection are well known. Accordingly, additional details concerning the internal construction of the computer 1100 need not be disclosed in connection with the present invention.

Those skilled in the art will understand that program modules such as the operating system 1126, the application programs 1128 and data 1132 are provided to the computer 1100 via one of its memory storage devices, which may include ROM 1108, RAM 1110, hard disk drive 1114, magnetic disk drive 1118, or optical disk device 1122. The hard disk drive 1114 is used to store data 1132 and the programs, including the operating system 1126 and application programs 1128.

When the computer 1100 is turned on or reset, the BIOS 1112, which is stored in ROM 1108 instructs the processing unit 1102 to load the operating system 1126 from the hard disk drive 1114 into the RAM 1110. Once the operating system 1126 is loaded into RAM 1110, the processing unit executes the operating system code and causes the visual elements associated with the user interface of the operating system to be displayed on the monitor. When a user opens an application program 1128, the program code and relevant data are read from the hard disk drive and stored in RAM 1110.

As described above, aspects of the present invention may be embodied in a World Wide Web (“WWW”) or (“Web”) site accessible via the Internet. As is well known to those skilled in the art, the term “Internet” refers to the collection of networks and routers that use the Transmission Control Protocol/Internet Protocol (“TCP/IP”) to communicate with one another. In accordance with an illustrative embodiment of the Internet, a plurality of local LANs and a WAN can be interconnected by routers. The routers are special purpose computers used to interface one LAN or WAN to another. Communication links within the LANs may be wireless, twisted wire pair, coaxial cable, or optical fiber, while communication links between networks may utilize 56 Kbps analog telephone lines, 1 Mbps digital T-1 lines, 45 Mbps T-3 lines or other communications links known to those skilled in the art. Furthermore, computers and other related electronic devices can be remotely connected to either the LANs or the WAN via a digital communication device, modem and temporary telephone, or a wireless link. The Internet has recently seen explosive growth by virtue of its ability to link computers located throughout the world. As the Internet has grown, so has the WWW.

As is appreciated by those skilled in the art, the WWW is a vast collection of interconnected or “hypertext” documents written in HyperText Markup Language (“HTML”), or other markup languages, that are electronically stored at or dynamically generated by “WWW sites” or “Web sites” throughout the Internet. Additionally, client-side software programs that communicate over the Web using the TCP/IP protocol are part of the WWW, such as JAVA® applets, instant messaging, e-mail, browser plug-ins, Macromedia Flash, chat and others. Other interactive hypertext environments may include proprietary environments such as those provided by an number of online service providers, as well as the “wireless Web” provided by various wireless networking providers, especially those in the cellular phone industry. It will be appreciated that the present invention could apply in any such interactive communication environments, however, for purposes of discussion, the Web is used as an exemplary interactive hypertext environment with regard to the present invention.

A Web site is a server/computer connected to the Internet that has massive storage capabilities for storing hypertext documents and that runs administrative software for handling requests for those stored hypertext documents as well as dynamically generating hypertext documents. Embedded within a hypertext document are a number of hyperlinks, i.e., highlighted portions of text which link the document to another hypertext document possibly stored at a Web site elsewhere on the Internet. Each hyperlink is assigned a Uniform Resource Locator (“URL”) that provides the name of the linked document on a server connected to the Internet. Thus, whenever a hypertext document is retrieved from any web server, the document is considered retrieved from the World Wide Web. Known to those skilled in the art, a web server may also include facilities for storing and transmitting application programs, such as application programs written in the JAVA® programming language from Sun Microsystems, for execution on a remote computer. Likewise, a web server may also include facilities for executing scripts and other application programs on the web server itself.

A remote access user may retrieve hypertext documents from the World Wide Web via a web browser program. A web browser, such as Netscape's NAVIGATOR® or Microsoft's Internet Explorer®, is a software application program for providing a user interface to the WWW. Using the web browser via a remote request, the web browser requests the desired hypertext document from the appropriate web server using the URL for the document and the HyperText Transport Protocol (“HTTP”). HTTP is a higher-level protocol than TCP/IP and is designed specifically for the requirements of the WWW. HTTP runs on top of TCP/IP to transfer hypertext documents and user-supplied form data between server and client computers. The WWW browser may also retrieve programs from the web server, such as JAVA applets, for execution on the client computer. Finally, the WWW browser may include optional software components, called plug-ins, that run specialized functionality within the browser.

Generally described, the present invention relates to a system and method for manipulating user display objects utilizing a hybrid list view model. More specifically, in accordance with aspects of the present invention, a hybrid method list view provides user display objects in a manner such that each display object may be selected and/or activated in accordance with both a single input selection, single input activation model and a single input selection, double input activation model. Accordingly, a user may utilize the hybird list view to manipulate display objects in accordance with a preferred manner.

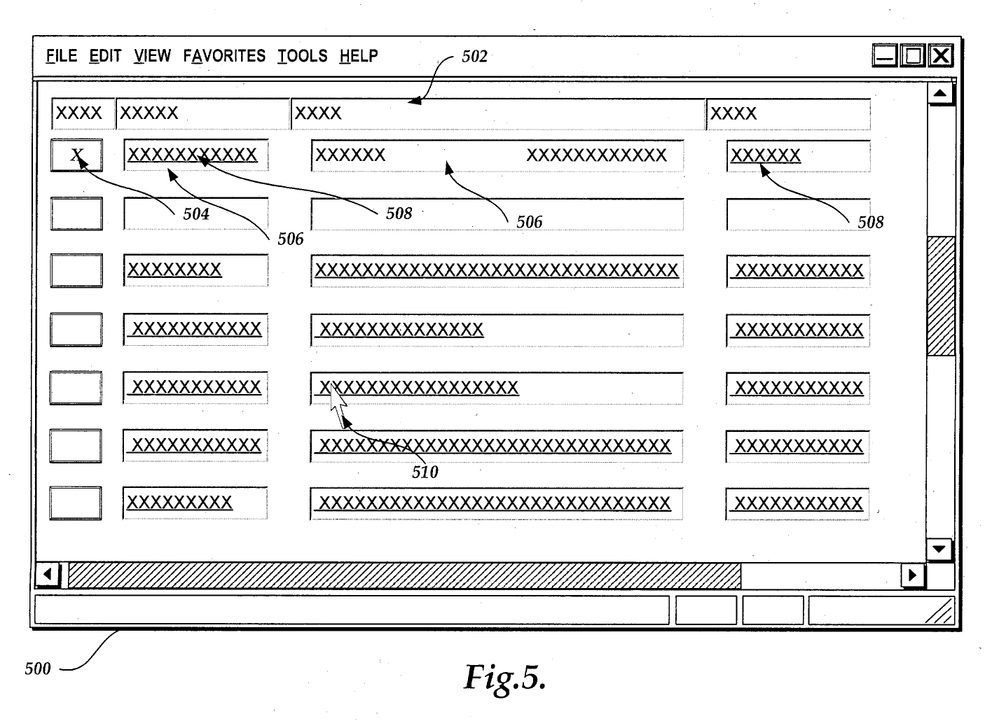

FIG. 5 is a block diagram illustrative of a screen display 500 utilizing a hybrid list view in accordance with the present invention. In accordance with an illustrative embodiment of the present invention, the screen display 500 corresponds to a table format having display objects corresponding to rows of graphic and text and a number of columns 502 specifying the information about each display object. Each row within the screen display 500 can be selected and/or activated by a number of actions inititated by the manipulation of a user selection device, such as a mouse, touch pad, touch sensitive screen, roller ball, voice commands, or other input devices. One skilled in the relevant art will appreciate that screen display 500 is illustrative in nature and should not be construed as limiting.

As illustrated in FIG. 5, the selection status of each display object may be toggled by a number of selection techniques corresponding to different selection methods. In one aspect, a display object may be “selected” or “unselected” by a user manipulation of a single input to a graphic control. In an illustrative embodiment of the present invention, the graphic control is a check box 504. However, alternative graphic controls may also be utilized. In another aspect, the display object selection status may also be toggled by a single input at any location corresponding to the display object that is does not correspond to any text or graphical portion of the display object, generally referred to as a background portion 506. As illustrated in FIG. 5, a single input on background portion 506 in the first, second or third column will result in a selection of the display object. In an illustrative embodiment of the present invention, the selection status of a display object may accompanied by additional visual indicators, such as hyperlinks.

The display object may also be activated by a combination of single input selections and/or double input selections. In one aspect, the display object may be activated by a single input on a foreground portion 508 of the display object. In an illustrative embodiment of the present invention, the foreground portion 508 may encompass all factual and graphical data pertaining to a display object. As discussed above, the actionable portion of a display object may be represented as a hyperlink. Alternatively, the foreground portion 508 may be limited to a selection of text/graphics. Further, in one embodiment of the present invention, each actionable piece of text/graphics corresponds to an activation of the same action by the computer system. Alternatively, each subsection of the foreground portion 508 may correspond to an initiation of a different action by the computer system. In another aspect, the display object may also be activated by a double input in the background portion of the display object 506.

With continued reference to FIG. 5, in an alternative embodiment of the present invention, the single input may correspond to a cursor remaining graphically over a specific foreground portion 508 for a period of time. This is generally referred to as a hover. In one embodiment of the present application, a hover results in at least a subset of the foreground portion being represented on the screen display as the single input actionable item when a cursor hovers over the text/graphic. For example, a piece of text may be modified to be represented as a hyperlink. Additionally, any other text or graphic of the foreground portion not directly adjacent to the cursor may not be presented as activatable. Thus the actionable portions may be dynamically modified by a user's actions.

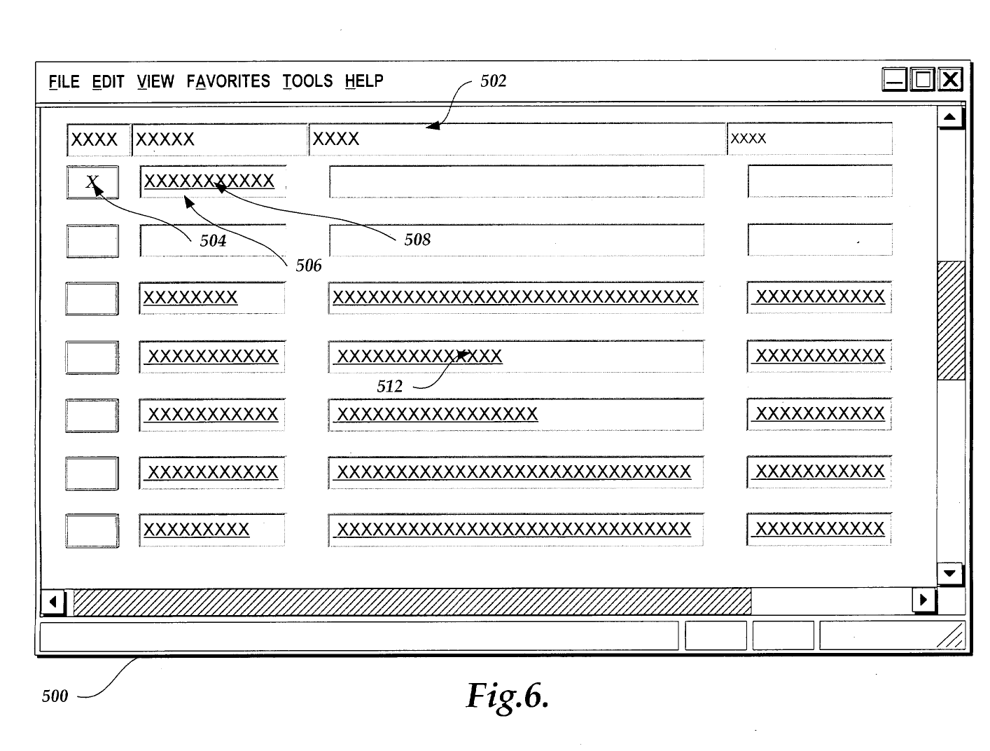

With reference now to FIG. 6, the hybrid list view embodiment may also utilize multiple selection controls in accordance with the present invention. In this embodiment, a user may manipulate either of the single input selection methodologies for toggling a display object selection status as described above with regard to FIG. 5. Further, the user may utilize multiple selection controls to provide for additional display object selection functionality. In an illustrative embodiment of the present invention, multiple selection controls can include a control for individually selecting a display object that adds the display objects to a grouping of display objects, generally referred to as concurrent selection. Additionally, the multiple selection controls can include an inclusive selection control tool such that the selection of an object will select all display objects from between the previously selected object and the most recently selected object.

In accordance with a first control embodiment, assuming that the first display has been previously selected, if a concurrent control has been selected, a selection of display object 512, by either the graphical control or a single input in background portion, will cause the first and fourth display objects to be grouped and selected. In accordance with a second control embodiment, if an inclusive multiple selection control is selected, then the first four display objects will be selected. Still further, a user may still manually select multipe display objects utilize the graphic selection control of each display objects.

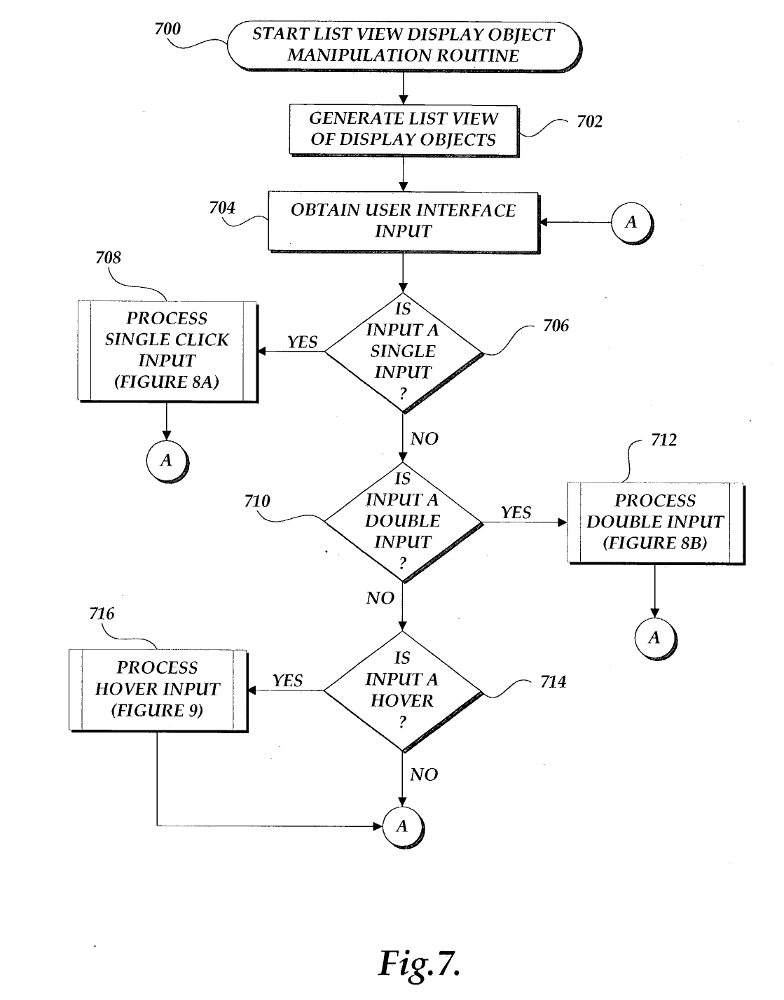

FIGS. 7-10 are flow diagrams illustrative of various routines and sub-routines utilized by a computing device to implement a hybrid list view in accordance with the present invention. FIG. 7 is a flow diagram illustrative of a display object manipulation routine 700 implemented by a computing device to present the hybrid list view in accordance with the present invention. At block 702, the computing device generates a list view of all display objects. As illustrated in FIGS. 5-6, the list view can be in a table format that includes a number of display objects as rows with one or more columns corresponding to attributes of each display object. However, one skilled in the art will appreciate that a list view may take a number of display embodiments and can be modified in accordance with the present invention. At block 704, the computing device obtains a user interface input. In an illustrative embodiment of the present invention, the user manipulation devices can include any number of devices that allow a user to indicate either a single input or a double input within a defined period of time. Accordingly, examples of suitable user input devices include computer mice, touch pads, touch screens, roller balls, voice commands and the like.

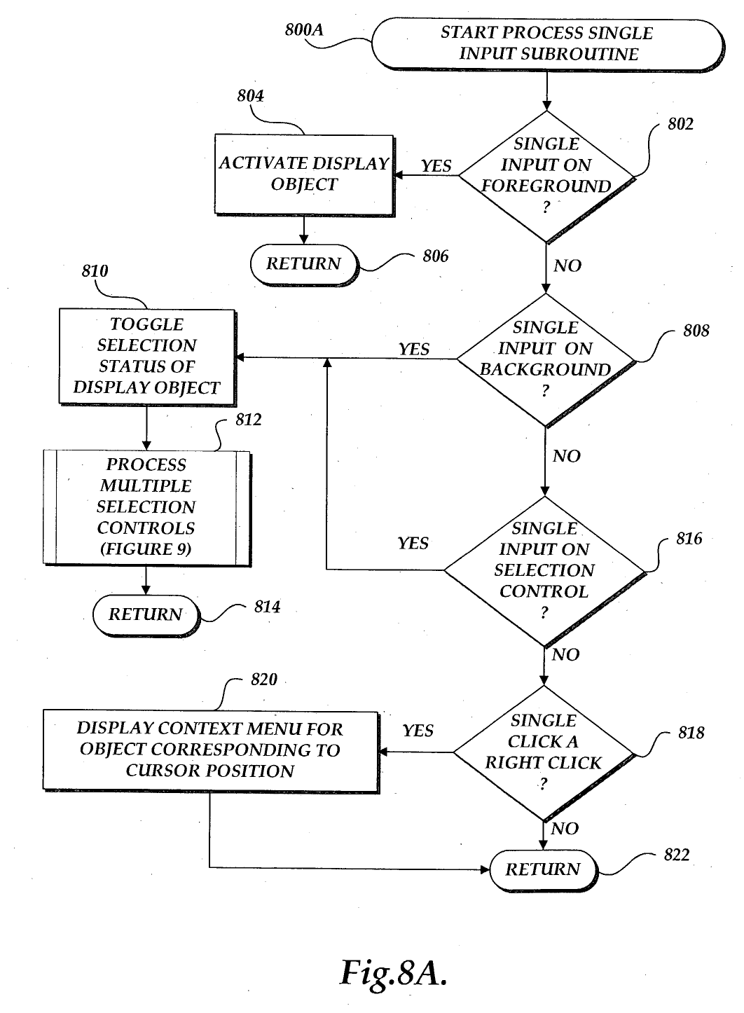

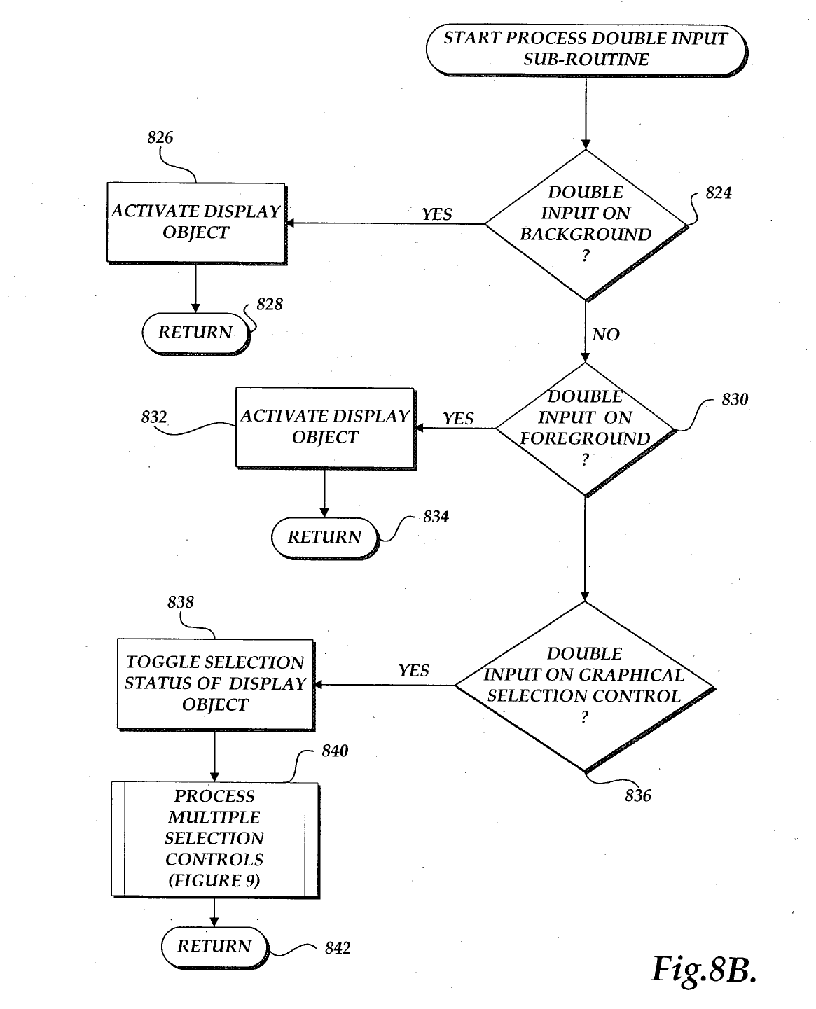

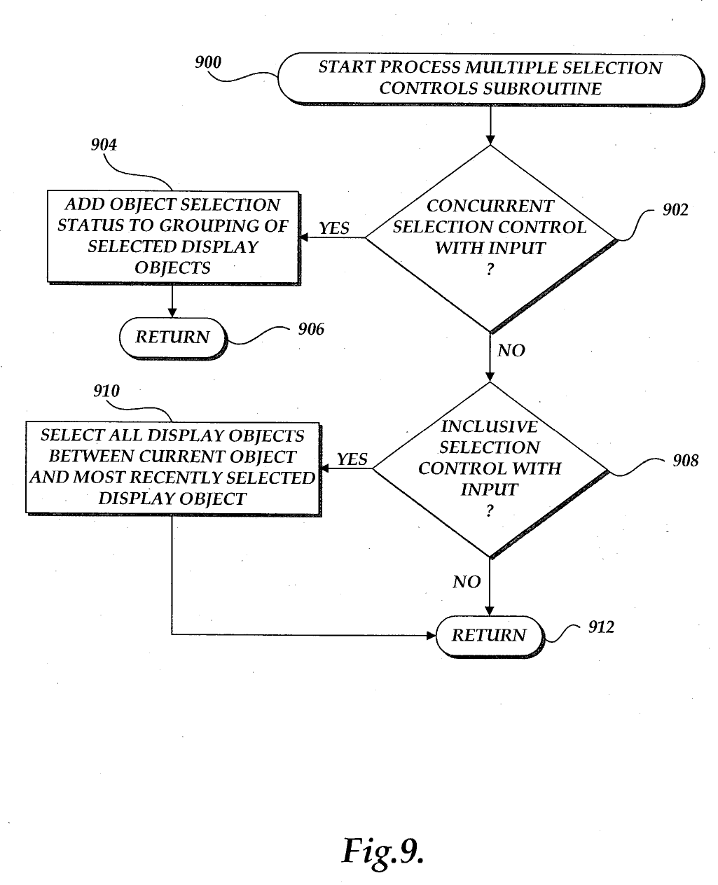

At decision block 706, a test is conducted to determine whether the user input is considered a single input. If the input is a single input, at block 708, the computing device processes the single input, which will be described in greater detail with regard to FIG. 8A. If the input is not a single input from the user selection device, at decision block 710, a test is conducted to determine whether the input is a double input from the user selection device. If the input is a double selection device, at box 712, the computing device processes a double input, which will be discussed in greater detail with regard to FIG. 8B. If the user input is not a double input, at decision block 714, a test is conducted to determine whether the input is a hover. If the input is a hover, the computing device processes the hover input at block 716, as will be discussed with regard to FIG. 9. Returning to decision block 714, if the input is not a hover, the routine 700 returns to block 704 to obtain the next user in interface input. In accordance with the present invention, the routine 700 continues until the user terminates the list view by terminating the program in accordance with the user interface.

Turning now to FIG. 8A, a process single input sub-routine 800A corresponding to block 708 (FIG. 8) will be described in accordance with the present invention. At decision block 802, a test is conducted to determine whether the single input is a single input corresponds to a foreground portion of the display object. If the input is a single input on a foreground portion of the display object, at block 804, the computing device activates an activity of display object. As described above, in one embodiment, the computing device may initiate a single action for a particular object regardless of which one of the foregoing portions is selected. Alternatively, the computing device may initiate a particular action corresponding to a particular portion of the foreground that was selected. At block 806, the sub-routine 800A returns to routine 700.

If the single input is not a single input on the foreground, at decision block 808, a test is conducted to determine whether the single input corresponds to a background portion of the display object. If the single input is on the background portion, at block 810, the computing device toggles the selection status of the display object. In an illustrative embodiment of the present invention, each display object has a selection status of either “selected” or “deselected.” Accordingly, if a single input is registered on an “unselected” display object, the object will be toggled to a selected status. Likewise, if a single input is registered on a “selected” display object, the selection status will be toggled to unselected. After toggling the selection of the status object, at block 812, the computing device processes any multiple selection controls, which will be described with regard to FIG. 9. At block 814, the sub-routine 800A returns to routine 700.

Returning to decision block 808, if the single input is not on a background portion of the display object, at decision block 816, a test is conducted to determine whether the single input is registered on a selection graphic control of the display object. As illustrated in FIG. 5, a selection graphic control can include check box 504. If the single input corresponds to a selection graphic control, sub-routine 800B proceeds to blocks 810 and 812 as described above to process a toggling of the selection status of the object.

Alternatively, if the single input does not correspond to a selection graphic control, at decision block 818, a test is conducted to determine whether the single input corresponds to an alternative input. In an illustrative embodiment of the present invention, some user selection devices will have two or more inputs for manipulating a cursor device. More specfically, the user selection devices typically have a left-most button, which registers an input as described above, and a right button which registers a different type of input. Accordingly, if the input is an alternative input, at block 820, the computing device can process the alternative input. For example, the computing device can display a context menu for the display object. The subroutine 800A returns to the routine 700A at block 822.

Turning now to FIG. 8B, a process double input sub-routine 800B corresponding to block 712 (FIG. 7) will be described. At decision block 824, a test is conducted to determine whether the double input corresponds to a background portion of the display object. If the double input corresponds to a background portion, at block 826, the computing device activates the display object and the routine 800B returns to routine 700 at block 828. If the double input does not correspond to a background portion of the display object, at decision block 830, a test is conducted to determine whether the double input is on a foreground portion of the display object. If the double input corresponds to a foreground, at block 832, the computing device activates the object corresponding to the text and the subroutine 800B returns to routine 700 at block 834. In an illustrative embodiment of the present invention, only a single input is required to activate the foreground portion of a disply object. Accordingly, a double input may be processed by the computing device as a single input to activate the object and the second input may be ignored.

If at decision block 830, the double input does not correspond to a foreground portion, at decision block 836, a test is conducted whether it is a double input corresponds to a selection graphical control. If the input corresponds to a selection graphical control, the computing device toggles the selection status of the display object at block 838. The computing device then processes multiple selection controls at block 840. At block 842, the sub-routine 800B returns to routine 700. Alternatively, if the double input is not an input on a selective graphical control, the sub-routine 800B returns to routine 700.

Turning now to FIG. 9, a multiple selection control processing routine 900 corresponding to various calling routines and sub-routines will be described. At decision block 902, a test is conducted to determine whether concurrent selection control was received with the input. In an illustrative embodiment of the present invention a concurrent selection control corresponds to a multiple selection control that allows for the grouping of individually selectable display objects.

If the concurrent selection control is received with a selection input at block 904, the display object selection status is toggled from a group of display objects. For example, if the display object was previously unselected in the group, the display object will become selected. Likewise, if the display object was previously selected with the group, the object will be unselected from the group. At block 906, the sub-routine 900 returns to the calling routine. If a concurrent selection control was not received with the input, at decision block 908, a test is conducted to determine whether an inclusive selection control was received with the input. If an inclusive selection control is received with the input at block 910, the computing device toggles the selection status all display objects between the currently selected display object and the most recently selected display object to the grouping of selected objects. The sub-routine 900 then returns to the calling routine at block 912.

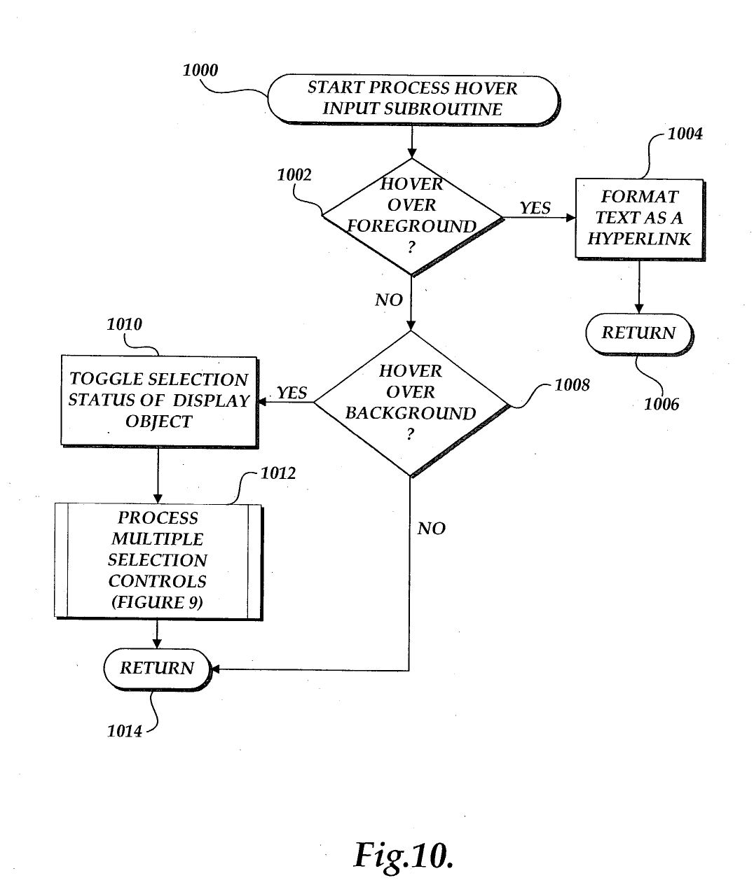

With reference now to FIG. 10, a process hover input sub-routine 1000 corresponding to block 716 (FIG. 7) will be described in accordance with the present invention. At decision block 1002, a test is conducted to determine whether the hover portion is over a foreground portion of the display object. If the hover of the user device is over a foreground portion, at block 1004, the computing device formats any text associated with the foreground portion as a hyperlink that may be activated by a single input as described above. At block 1006, the subroutine 1000 returns to the calling routine.

At block 1008, a test is conducted whether the hover portion is over a background of the display object. If the hover is over background portion of the display object, at block 1010, the computing device toggles the selection of the status of the object, and the computing device processes multiple selection controls at block 1012. In an illustrative embodiment of the present invention, the hover may have to occur for a predetermined period of time. Further, this feature may be omitted altogether. The sub-routine 1000 then returns to routine 700 at block 1014.

By utilizing multiple selection controls and presented methods, the present invention facilitates the activation of display objects and/or selection display objects by a user. However, the user is not limited to any one display method and can select a preferred selection/activation method.

While illustrative embodiments of the invention have been illustrated and described, it will be appreciated that various changes can be made therein without departing from the spirit and scope of the invention.

The embodiments of the invention in which an exclusive property or privilege is claimed are defined as follows:

1. In a computer system having a display and a selection device for registering single and double inputs, a method for managing display objects in a screen display presented on the computer system display, wherein each display object can be selected for manipulation and activated to cause performance of some action within the computer system, the method comprising:
obtaining a set of display objects corresponding to a screen display, wherein each display object includes a graphical control for selecting the display object with a single input, at least one foreground portion for activating the display object with a single input, and a background portion for selecting the display object with a single input and activating the display object with a double input;
generating a screen display including the set of display objects;
obtaining a user input generated by the selection device, wherein the user input corresponds to one of the set of display objects in the screen display; and
processing the user input corresponding to a display object in the screen display.

2. The method as recited in claim 1, wherein the user input corresponding to a display object includes a single input on the graphical control of the display object and wherein processing the user input includes toggling a selection status of the display object.

3. The method as recited in claim 2, wherein the graphical control is a check box.

4. The method as recited in claim 1, wherein the user input corresponding to a display object includes a single input on the foreground portion of the display object and wherein processing the user input includes activating the display object.

5. The method as recited in claim 4, wherein the foreground portion corresponds to graphics represented as a hyperlink.

6. The method as recited in claim 4, wherein the foreground portion includes at least two foreground portions for activating the display object by a single input.

7. The method as recited in claim 6, wherein a single input on each of the at least two foreground portions corresponds to an activation of a same action.

8. The method as recited in claim 6, wherein a single input on each of the at least two foreground portions corresponds to an activation of a different action.

9. The method as recited in claim 1, wherein the user input corresponding to a display object includes a single input to the background portion of the display object and wherein processing the user input includes toggling a selection status of the object.

10. The method as recited in claim 1, wherein the user input corresponding to a display object includes a double input to the background portion of the display object and wherein processing the user input includes activating the display object.

11. The method as recited in claim 1, wherein the user input corresponding to a display object includes a hover over the display object.

12. The method as recited in claim 11, wherein processing the user input includes toggling a selection status of the display object.

13. The method as recited in claim 11, wherein processing the user input includes highlighting the display object.

14. The method as recited in claim 11, wherein processing the user input includes converting at least a portion of the foreground portion corresponding to the hover input into a hyperlink.

15. The method as recited in claim 1, wherein the user input corresponding to a display object includes a selection of a multiple selection control and wherein processing the user input includes toggling a selection status of the display object to a grouping of display objects.

16. The method as recited in claim 1, wherein the user input corresponding to a display object includes a selection of a multiple selection control and wherein processing the user input includes selecting all display objects between the display object and a most recently selected display object.

17. The method as recited in claim 1, wherein the selection device is selected from a group consisting of a computer mouse, a touch pad, a touch screen, a roller ball and a keyboard.

18. The method as recited in claim 1, wherein the display objects correspond to rows in a table having at least one column.

19. A computer-readable medium having computer-executable components for implementing method for managing display objects in a screen display presented in a computer system having a display and selection device for registering single and double inputs, wherein each display object can be selected for manipulation and activated to cause performance of some action within the computer system, the method comprising:
obtaining a set of display objects corresponding to a screen display, wherein each display object includes a graphical control for selecting the display object with a single input, at least one foreground portion for activating the display object with a single input, and a background portion for selecting the display object with a single input and activating the display object with a double input;
generating a screen display including the set of display objects;
obtaining a user input generated by the selection device, wherein the user input corresponds to one of the set of display objects in the screen display; and
processing the user input corresponding to a display object in the screen display.

20. The method as recited in claim 19, wherein the user input corresponding to a display object includes a single input on the graphical control of the display object and wherein processing the user input includes toggling a selection status of the display object.

21. The method as recited in claim 19, wherein the user input corresponding to a display object includes a single input on the foreground portion of the display object and wherein processing the user input includes activating the display object.

22. The method as recited in claim 21, wherein the foreground portion includes at least two foreground portions for activating the display object by a single input.

23. The method as recited in claim 19, wherein the user input corresponding to a display object includes a single input to the background portion of the display object and wherein processing the user input includes toggling a selection status of the object.

24. The method as recited in claim 19, wherein the user input corresponding to a display object includes a double input to the background portion of the display object and wherein processing the user input includes activating the display object.

25. The method as recited in claim 19, wherein the user input corresponding to a display object includes a hover over the display object.

26. The method as recited in claim 19, wherein the user input corresponding to a display object includes a selection of a multiple selection control and wherein processing the user input includes toggling a selection status of the display object to a grouping of display objects.

27. The method as recited in claim 19, wherein the user input corresponding to a display object includes a selection of a multiple selection control and wherein processing the user input includes selecting all display objects between the display object and a most recently selected display object.

28. The method as recited in claim 19, wherein the selection device is selected from a group consisting of a computer mouse, a touch pad, a touch screen, a roller ball and a keyboard.

29. In a computer system having a display and a selection device for registering single and double inputs, a method for managing display objects in a screen display presented on the computer system display, wherein each display object can be selected for manipulation and activated to cause performance of some action within the computer system, the method comprising:
obtaining a set of display objects corresponding to a screen display, wherein each display object includes a graphical control for selecting the object with a single input and a background portion for selecting an object with a single input;
generating a screen display including the set of display objects;
obtaining a user input generated by the selection device, wherein the user input corresponds to one of the set of display objects in the screen display and is selected from a group comprising a single input on the graphical control of the display object and a single input on the background portion of the display object; and
toggling a selection status of the display object in the screen display.

30. The method as recited in claim 29, wherein the user input corresponding to a display object includes a selection of a multiple selection control and wherein processing the user input includes toggling a selection status of the display object to a grouping of display objects.

31. The method as recited in claim 29, wherein the user input corresponding to a display object includes a selection of a multiple selection control and wherein processing the user input includes selecting all display objects between the display object and a most recently selected display object.

32. The method as recited in claim 29, wherein toggling the selection status of the display object includes toggling a visual indicator of the selection status of the display object.

33. The method as recited in claim 29, wherein the selection device is selected from a group consisting of a computer mouse, a touch pad, a touch screen, a roller ball, and a keyboard.

34. The method as recited in claim 29, wherein the display objects corresponds to rows in a table having at least one column.

35. A computer-readable medium having computer-executable components for implementing method for managing display objects in a screen display presented in a computer system having a display and selection device for registering single and double inputs, wherein each display object can be selected for manipulation and activated to cause performance of some action within the computer system, the method comprising:
obtaining a set of display objects corresponding to a screen display, wherein each display object includes a graphical control for selecting the object with a single input and a background portion for selecting an object with a single input;
generating a screen display including the set of display objects;
obtaining a user input generated by the selection device, wherein the user input corresponds to one of the set of display objects in the screen display and is selected from a group comprising a single input on the graphical control of the display object and a single input on the background portion of the display object; and
toggling a selection status of the display object in the screen display.

36. The method as recited in claim 35, wherein the user input corresponding to a display object includes a selection of a multiple selection control and wherein processing the user input includes toggling a selection status of the display object to a grouping of display objects.

37. The method as recited in claim 35, wherein the user input corresponding to a display object includes a selection of a multiple selection control and wherein processing the user input includes selecting all display objects between the display object and a most recently selected display object.

38. The method as recited in claim 35, wherein toggling the selection status of the display object includes toggling a visual indicator of the selection status of the display object.

39. The method as recited in claim 35, wherein the selection device is selected from a group consisting of a computer mouse, a touch pad, a touch screen, a roller ball, and a keyboard.

40. The method as recited in claim 35, wherein the display objects corresponds to rows in a table having at least one column.

41. In a computer system having a display for displaying display objects that can be selected for manipulation and activated to cause the performance of an action within the computer system and a user interface device for generating single and double inputs, a computer-readable medium having computer-readable components corresponding to each display object in the display, the computer-executable components comprising:
a graphical control component for toggling a selection status of the display object with a single input;
a foreground component for activating the display object with a single input; and
a background component for toggling the selection status of the display with a single input and for activating the display object with a double input.

42. The computer-readable components as recited in claim 41, wherein the graphical control components includes a check box.

43. The computer-readable components as recited in claim 41, wherein the foreground component includes graphics represented as a hyperlink.

44. The computer-readable components as recited in claim 41, wherein the foreground component includes at least two foreground portions for activating the display object with a single input.

45. The computer-readable components as recited in claim 44, wherein a single input in each of the at least two foreground portions corresponds to an activation of the same action.

46. The computer-readable components as recited in claim 44, wherein a single input in each of the at least two foreground portions corresponds to an activation of different actions.

47. The computer-readable components as recited in claim 41, wherein the graphical control component, foreground component and background component are represented as rows in a column having at least one column.
